(19) United States
(12) Patent Application Publication
(10) Pub. No.: US 2025/0314479 A1
(43) Pub. Date: Oct. 9, 2025

(54) MODULAR OPTICAL SENSOR SYSTEM FOR BEND LOCALIZATION

(71) Applicant: UNIVERSITY OF LOUISVILLE RESEARCH FOUNDATION, INC., Louisville, KY (US)

(72) Inventors: Paul Bupe, JR., Louisville, KY (US); Cindy K. Harnett, Louisville, KY (US)

(73) Assignee: UNIVERSITY OF LOUISVILLE RESEARCH FOUNDATION, INC., Louisville, KY (US)

(21) Appl. No.: 19/097,952

(22) Filed: Apr. 2, 2025

Related U.S. Application Data
(60) Provisional application No. 63/573,663, filed on Apr. 3, 2024.

(51) Int. Cl. G01B 11/16

(52) U.S. Cl. CPC G01B 11/16

(57) ABSTRACT

A soft optical bend localization sensor system is a novel sensor system that is low cost, flexible, simple to fabricate, and able to perform real-time bend localization on almost any modern microcontroller. Air gaps in flexible optical light pipes create coded patterns for use in bend localization. The sensor system allows for the creation of extrinsic intensity modulated bend sensors that function as flexible absolute linear encoders. The system allows for real-time and accurate bend localization in many robotics and automation applications, in both wet and dry conditions.

### CROSS-REFERENCE TO RELATED APPLICATIONS

This application claims the benefit of U.S. Provisional Application No. 63/573,663, filed Apr. 3, 2024 entitled “MODULAR OPTICAL SENSOR SYSTEM FOR BEND LOCALIZATION” which is herein incorporated by reference in its entirety.

### GOVERNMENT RIGHTS

This invention was made with government support under contract no. 1935324 awarded by the National Science Foundation. The government has certain rights in the invention.

### BACKGROUND

The invention generally relates to optical sensor systems and, more particularly, optical sensor systems and related methods for applications such as but not limited to bend localization.

Some sensors allow for measuring flexion, extension, and lateral planes. Other sensors measure pressure by correlating the increase in optical intensity as the faces of two fibers align due to an external force. However, none of these sensors provide information on bending location.

Soft optical deformation sensors can sometimes be useful with soft robotics because their mechanical properties match, their materials are compatible with rapid prototyping, and they are less susceptible than electronic sensors to electromagnetic noise and temperature drift. However, options for localizing the deformation are lacking.

Some aspects of the art in soft bend localization utilize fiber Bragg gratings (FBG). This technology sometimes requires sophisticated, expensive equipment to manufacture as well as to use. FBG sensors also have the drawback of not being able to undergo sharp bends without breaking.

Some embodiments of the invention address one or more of the deficiencies described above.

### SUMMARY

An aspect of some exemplary embodiments is a bend localization sensor system. Such system may be low cost, flexible, simple to fabricate, able to perform real-time bend localization, and/or implemented with any modern microcontroller to handle digital signal processing.

An aspect of some exemplary embodiments is sensors which have gaps (e.g., air gaps) in flexible optical light pipes (such as optical fiber) to create coded segments for use as intensity modulated bend localization sensors. Bend localization may be described as the ability to determine the location at which an object is bent in reference to a known point. A simple example is that of a human arm where the major bend locations (elbow and wrist) are fixed. A bend localization sensor would be able to tell, for example, that a bend occurred 26 cm from the reference point (the shoulder) which would be the elbow bending or that a bend occurred 53 cm from the reference point, which would be the wrist bending. The usefulness of such a sensor is in the more realistic scenarios in robotics applications where the location of bending can move.

An exemplary system implements not merely a bend sensor but instead a bend localization sensor—a key distinction. An exemplary application is in soft robotics, such as in bistable or articulated systems. A user may choose where to place bend sensitive segments along the sensor, e.g., simply by cutting and reattaching with a sleeve. An exemplary sensor also works with different materials, allowing for true flexibility in applications such as being embroidered into clothing.

Exemplary embodiments may have advantages which include but are not limited to one or more of the following: cheap to manufacture, customizable, reconfigurable and able to be rapidly cut and assembled to size on-site, operational in open air and underwater, and able to bend to acute angles without breaking.

This sensor system has the potential for use in many robotics and automation systems that require flexibility, reconfiguration, and noise immunity—this includes underwater conditions. The ability to use various light pipe materials with the same sensor system based on the application puts exemplary systems at a heightened advantage over other sensors. An exemplary sensor system may have all its signal processing integrated into a small custom hardware package which performs automated fitting of new sensor patterns.

Some exemplary sensors may be viewed functionally as a flexible absolute linear encoder that uses an air gap with a rubber sleeve to create coded bend sensitive segments in parallel light pipes.

An exemplary sensor system may comprise, for example, infrared (IR) light-emitting-diode (LED) emitters, flexible light pipes in parallel, and a photodarlington detector. The emitters and detectors may be controlled by a single or multiple microcontrollers. An exemplary air gap may be created by making a slice perpendicular to an optical fiber axis. This models a circular fiber face translated across another face and the overlap area gives the amount of optical transmission. Deformations (e.g., bends) which reduce overlap area reduce the percent of light (signal) which bridges the gap to renter fiber.

In some embodiments, coded segment patterns may be identified using a Gaussian naive Bayes (GNB) classifier running on a microcontroller. Fitting of the classifier may be performed externally to a sensor system to simplify data collection and processing from the sensor in its eventual state-of-use context. Exemplary sensors may use almost any combination of different types of optical light pipe materials as well as emitters and detectors.

Bending a fiber with no air gap results in minimal loss of light. Conversely, an air gap significantly reduces transmittance as the bend angle increases. Bend sensitivity may be created at desired locations by cutting a light pipe and then re-attaching the pieces together using a sleeve to create a small air gap. This is done on each of the multiple light pipes in order to create air gap patterns (or codes) used for bend localization. Particular fabrication of any one sensor is entirely dependent on the application for that particular sensor. This is especially true of the placement of the bend-sensitive air gap patterns.

Some exemplary sensors may be embedded or embeddable, e.g., in fabric, non-woven, cloth, silicone, etc. An exemplary sensor may be embedded directly into some fabric or device during fabrication of that fabric or device.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The following drawings form part of the present specification and are included to further demonstrate certain aspects of the present invention. The invention may be better understood by reference to one or more of these drawings in combination with the description of specific embodiments presented herein.

FIG. 1A is an exemplary sensor system.

FIG. 1B is an exemplary sensor.

FIG. 1C is a cross-section of an exemplary sensor.

FIG. 2 is a simulation and model showing the main working principle of an exemplary air gap.

FIG. 3 is an exemplary sensor system configured with physical components.

FIG. 4 is a visualization of how sensor array gap patterns correspond with a binary bit stream and optical intensity signals.

FIG. 5 summarizes exemplary signal processing stages for noise reduction.

FIG. 6A is a plot of transmittance as a function of bend angle (deg) when bending a 1 mm piece of PMMA fiber.

FIG. 6B is a plot of transmittance as a function of bend angle (deg) when bending fiber at the location of an air gap.

FIG. 7 shows simulated effect of light source cone angle (deg) on transmittance for three sample bend angles.

FIG. 8 is an exemplary graphical user interface (GUI) created to facilitate fast testing, labeling, and fitting of data for an exemplary sample system.

FIG. 9 is signal level output for a sensor consisting of three 0.5 mm PMMA optical fibers attached to a tape spring testing rig showing how the bend location corresponds to the air gap pattern.

FIG. 10 is light pipes embroidered into fabric.

### DETAILED DESCRIPTION

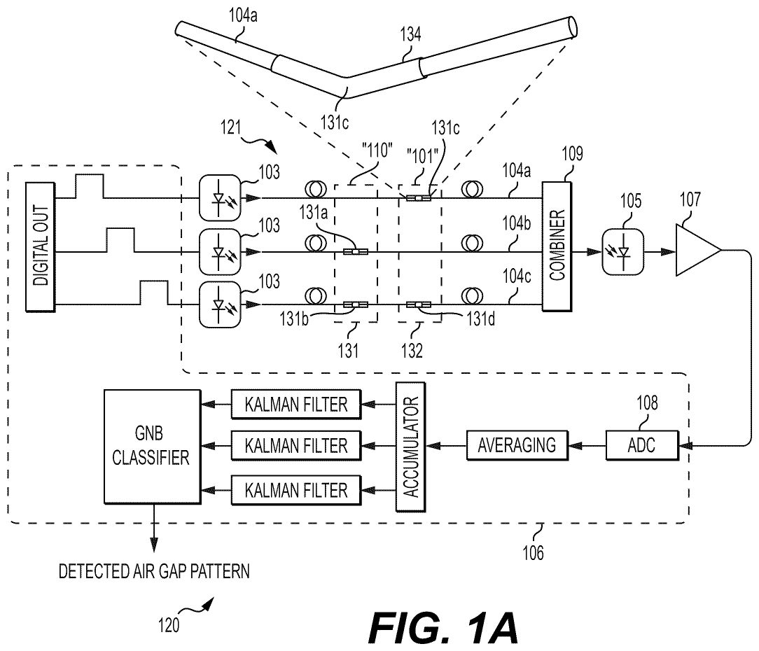

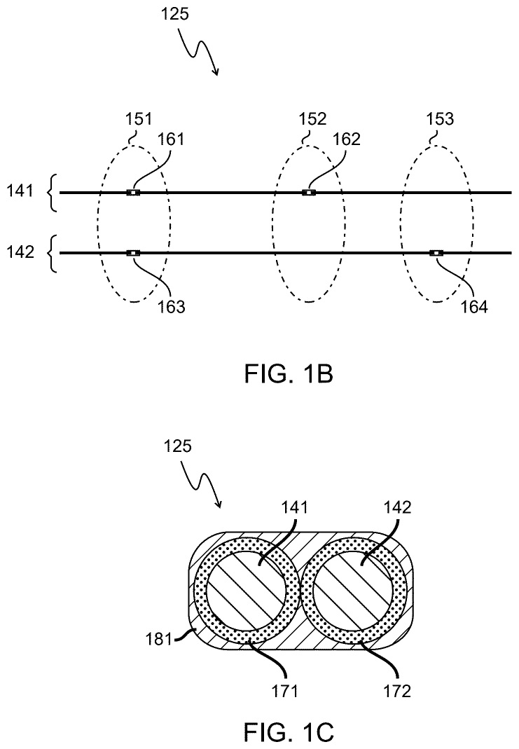

FIG. 1A illustrates an exemplary sensor system 120 which incorporates a fiber optic sensor (FOS) 121. The sensor system 120 has three main components. The first is one or more emitters 103, e.g., infrared (IR) light-emitting-diode (LED) emitters. The second is two or more light pipes (waveguides) 104 which in some exemplary embodiments are arranged in parallel with one another and are flexible. The third is one or more detectors 105, e.g., a photodarlington detector. In addition, the system 120 includes one or more controllers, such as microcontroller 106. The controller 106 interprets the information collected by the light pipes 104. The system 120 also includes, by way of example, other optical and/or electrical elements which may be included depending on the embodiment. Here, system 120 includes a combiner 109 between the light pipes 104 and detector 105. The system 120 further includes an amplifier 107 between the detector 105 and controller 106. FIG. 1A includes inside the block representative of controller 106 a flow chart of exemplary functionalities for which the controller 106 is programmed to perform. Details of the blocks illustrated within controller 106 in FIG. 1A will be described in greater detail below.

Functionally, a sensor system 120 is suited for exemplary applications such as but not limited to deformation (e.g., bend) detection, and more particularly, to deformation localization. Deformation detection, as a general matter, may include the capacity to recognize when one or more light pipes in the system are deformed, e.g., due to an external force which causes a deformation to one or more of the light pipes. The light pipes, and in particular localized features of the light pipes, are configured so that one or more transmission properties change in dependence on shape, e.g., as affected by external forces which move at least part of the light pipe relative to some other part of the same light pipe. As a simple example of a change in shape, a light pipe which is arranged completely linear along its entire length may be bent so that it is no longer completely linear along its length. The light pipe may be configured so that the percent of light transmitted by the pipe differs when the pipe is completely straight versus when the pipe is bent. A light pipe may be configured so that bending the light pipe at one location along its length and bending the light pipe at a different location along its length lead respectively to different effects on the whole light pipe's transmission of light. Alternatively, a single light pipe alone may not, on its own, convey sufficient information to localize a deformation. However a group of lights pipes working collectively as a sensor may be configured such that, as a collective, bending the light pipes at one location along their length and bending the group at a different location along their length leads respectively to different effects on the whole group's transmission of light.

Deformation localization is a particular advantage of exemplary sensors and systems. Localization refers to recognizing not only that a pipe has been deformed (e.g., bent) somewhere along its length, but also to recognizing that a deformation has occurred (or is occurring) at a particular point or segment along the total length, and correspondingly not at other points or segments along the total length. For purposes of this disclosure, individual points or segments to which deformation may be localized may be associated generally with respective locations. FIG. 1 portrays a first location 131 and a second location 132. An advantage of many exemplary embodiments is that the total number of distinct locations at which the sensor or system can sense/recognize a local deformation exceeds the total number of light pipes required by the sensor or system by at least one. Said differently, for a sensor or system with n light pipes, the number of unique locations at which local deformation is detectable is at least n+1.

For purposes of this disclosure, the word “sensor” may refer to a device with one or multiple light pipes. In general, however, an exemplary sensor 121 (and exemplary system 120 incorporating such a sensor) has at least two light pipes-which may be nominally distinguished as a first light pipe and a second light pipe-configured with an ability to distinguish deformations among at least three distinct locations. In contrast to light pipes employed in applications desiring as near to absolute signal integrity from end-to-end for any light pipe (e.g., fiber optic Internet service), exemplary light pipes according to present embodiments are configured to have localized physical features between respective ends of the light pipes which intentionally affect (e.g., distort, alter, vary, etc.) signals being conveyed by the light pipes.

For many embodiments of this disclosure, “one” light pipe corresponds with one light path. One light path may generally begin at an emitter and end at a detector. According to this understanding, if a device has light paths which branch, each branch may be regarded as a separate light pipe. Losses from a light pipe, including intentional losses, in general are not separate light paths and do not bear on the number of light pipes. Two segments of optical fiber connected end-to-end so that light leaving one segment tends to enter the other segment form a single light path and constitute a single light pipe, even if some light is lost between the segments. Any number of segments of fiber may be connected in series to form a single light path and single light pipe. Multiple fibers arranged in parallel, however, generally constitute multiple light pipes.

A central feature of exemplary embodiments is a plurality of gaps in each light pipe among multiple light pipes. Bend-sensitive air gaps along a pipe/fiber concentrate mechanical deformations in the light pipe to predetermined locations. An exemplary gap may be achieved by, for example, cutting the fiber (e.g., as by but not limited to a cut perpendicular to the fiber axis) and then re-attaching the newly created intermediate faces together. By re-attaching, what is meant is that the newly made opposing faces are placed into a specific physical arrangement with one another that is retained under equilibrium conditions. In a state of equilibrium (e.g., forces acting on the fiber are not changing), the physical arrangement of opposing faces is constant (e.g., the shape and size of an air gap between the opposing faces does not change). The opposing faces of the fiber created by the cut may be held together in a fixed equilibrium arrangement using, for example, tubing or sleeve 134 which leaves a small air gap between the opposing faces enclosed by the sleeve 134. An exemplary sleeve 134 is configured to be deformable but restorable after the force(s) causing deformation is/are removed. An exemplary material is an elastic material, such as but not limited to silicone.

While “air gap” is used to describe some exemplary embodiments, embodiments may be varied in the practice of the invention to fill the gap with a medium other than air, e.g., a resin, dye, and/or something else. Air is a convenient “fill” for the gap, but the term “air gap” used in this disclosure should be understood to mean “gap” with air as a non-limiting example of what may be inside the gap. A gap and the arrangement that provides the gap with an elastic behavior may be configured so that more light leaks from the gap when it is deformed than when it is undeformed. Alternatively, it is possible for the opposite to be true of one or more gaps in some embodiments. That is to say, in some embodiments, a gap and the arrangement that provides the gap with an elastic behavior may be configured so that less light leaks from the gap when it is deformed than when it is undeformed.

FIG. 1A portrays a first location 131 and a second location 132. Minimum distances required between locations so that the sensor or system can distinguish a deformation at one of these locations from a deformation at another of these locations is discussed in greater detail below. In FIG. 1A, air gap 131a (of light pipe 104b) and air gap 131b (of light pipe 104c) share location 131 with one another. Meanwhile location 132 is shared by air gap 131c (of light pipe 104a) and air gap 131d (of light pipe 104c). Any one location has its air gaps contributed by a unique set/combination of light pipes 104. For instance, the specific collection of air gaps (sometimes referred to in this disclosure as a “sensor array gap pattern”) belonging to location 131 are contributed by a first grouping of light pipes 104. Namely, of the total available light pipes 104 (the group consisting of pipes 104a, 104b, and 104c), the grouping of pipes contributing gaps to location 131 consists of pipes 104b and 104c (to the exclusion of pipe 104a). By contrast, the specific collection of air gaps belonging to location 132 are contributed by a second grouping of light pipes 104 which differs from the first grouping. Namely, the grouping of pipes contributing gaps to location 132 consists of pipes 104a and 104c (to the exclusion of pipe 104b). A third location (not illustrated) may have gaps from all the available pipes 104a, 104b, and 104c. Though any one light pipe may contribute separate gaps to multiple separate locations (and in fact it is advantageous to do so), each location is unique with respect to the particular set of pipes which contribute at least one gap to that location. This is to say each unique location corresponds with a unique gap pattern. This requirement may not apply to all embodiments, e.g., in a sensor or system in which one or more gaps are configured to produce different effects on light transmission when deformed compared to one or more other gaps. In a sensor or system in which each gap has substantially the same light transmission properties as other gaps given the same externalities, then it is desirable that each location has a unique group of light pipes contributing gaps to that location.

FIG. 1B is an exemplary optical sensor 125 which embodies a minimal set of features which are nevertheless able, in combination, to cause the sensor 125 to have the advantage of being usable to detect/recognize a greater number of local deformations than there are light pipes. The sensor 125 may be used for localizing deformations among at least a first location 151, second location 152, and third location 153. The sensor 125 comprises a first light pipe 141 comprising along its length at least a first gap 161 and a second gap 162. The sensor 125 further comprises a second light pipe 142 comprising along its length at least a third gap 163 and a fourth gap 164. The first gap 161 and third gap 163 are constrained to share the single first location 151 in space. The second gap 162 has a second location 152 in space which is not shared with the first gap 161, third gap 163, or fourth gap 164. The fourth gap 164 has a third location 153 in space which is not shared with the first gap 161, second gap 162, or third gap 163. Each of the gaps 161, 162, 163, and 164 is configured to have light transmission properties which change in response to deformation. For instance, each of the gaps may be configured to leak more light from the light pipe to which it belongs the greater the deformation to which the respective light pipe is subjected in the vicinity of the gap (which is to say, at the corresponding location of the gap). Transmission losses (e.g., attenuation) is but one exemplary light transmission property that deformation may affect. Some embodiments may be configured so that deformations lead to other changes in transmission properties. For example, what frequencies or frequency bands are passed, blocked, and/or attenuated may vary at a gap based on the amount of deformation to the light pipe at the location of a gap. Embodiments may be configured so that, based on local deformation, gaps modulate one or more of wavelength, polarization, phase, intensity, or a combination of these.

Note that generally, which of multiple like-named elements may be qualified as “first”, “second”, “third”, etc. is arbitrary. For instance, of two gaps, which is labeled “first gap” and which is labeled “second gap” is arbitrary, and the arbitrary names may be exchanged for one another. Light may reach the “second” gap before it reaches the “first” gap. Light may reach the “first” gap before it reaches the “second” gap. Said differently, whichever gap the light reaches first may be referred to as the “first gap” or as the “second gap”, since the naming is not intended to imply a particular sequence, only a counting of distinct “gaps”, where the counting does not itself require any order as to which gap is counted ahead or behind any other gap.

FIG. 1C is an exemplary physical cross-section of the sensor 125. Light pipe 141 has a cladding 171 which exists at least around each gap in light pipe 141. The cladding 171 may extend continuously the entire length of light pipe 141. Light pipe 142 has a cladding 172 which exists at least around each gap in light pipe 142. The cladding 172 may extend continuously the entire length of light pipe 142. A further cladding 181 is provided at least at each of the locations 151, 152, and 153 to constrain the gaps in the respective location to stay together. This is one exemplary means for ensuring the particular unique group of gaps belonging to a particular location remains constant. Functionally, the light pipes in between detection locations may or may not be physically constrained to maintain any particular physical distance from one another. That being said, it may be advantageous in some embodiments, e.g., from a manufacturing and/or sensor integrity perspective, to constrain an entirety of light pipe 141 relative to light pipe 142. This may be accomplished by, for example, cladding 181 extending substantially the entire length of the sensor 125. The claddings 171, 172, and 181 are adequately deformable to allow opposing fiber faces at respective gaps to move enough relative to one another in the presence of adequate external forces for light transmission to change across the intervening gap, e.g., for more or less light which exits one face to enter the opposing face depending on the presence/absence of deformation or the extent of deformation applied. An exemplary gap may entail fiber faces which are spaced apart, e.g., 4 mm or less, 3 mm or less, 2 mm or less, 1 mm or less, 0.5 mm or less, 0.1 mm or less, 0.05 mm or less, or 0.01 mm or less.

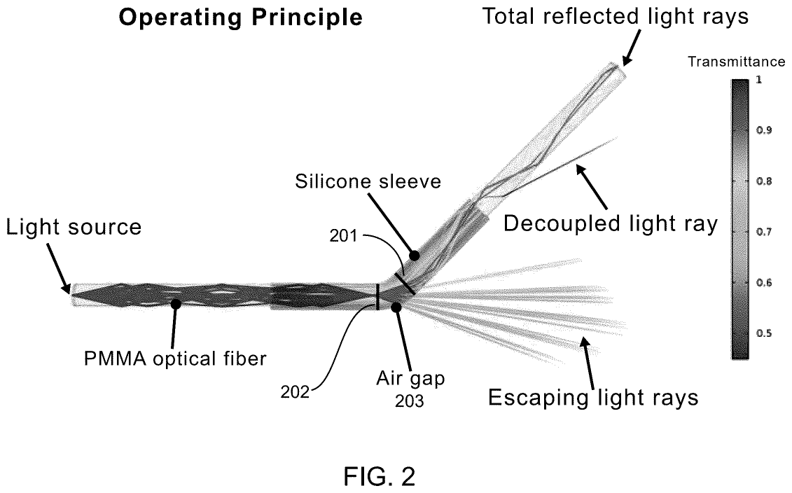

FIG. 2 presents a simulation and ray optics model showing the main working principle of an exemplary air gap. The model is bent at a 45° angle with a 15° cone angle light source and shows a significant amount of light escaping at the gap. Translation and/or rotation of one fiber face 201 relative to the other fiber face 202 changes the fraction of light transmitted across the gap 203. The greater the bend angle to the light pipe in the location of the air gap 203, the more light escapes and the less light traverses the gap to enter the opposing fiber face. The resulting change in intensity of the optical signal is then correlated with known deformation for use as a sensor.

Returning to FIG. 1A, discussion will now elaborate upon exemplary optical source(s) 103, detector(s) 105, and (micro) controller(s) 106. The number and particular characteristics of optical source and detector may vary among embodiments. A variety of suitable optical sources and detectors are available commercially at the time of this disclosure for use in optical devices generally. While any type of light source may be used in an exemplary sensor and system, light in the infrared (IR) spectrum is advantageous for many sensor applications. Because of the gaps created in the light pipes, it may be possible (e.g., depending on the choice of cladding(s)) for ambient light to enter the system and raise the overall optical noise floor. In such case, using a light source and detector in the IR spectrum provides advantageous immunity to most ambient light sources (namely those which do not emit in the IR spectrum), allowing the sensor to work in more conditions.

In the system 120 of FIG. 1A, the light pipes 104a, 104b, and 104c all terminate into a single detector 105. Accordingly, the combiner 109 is advantageously arranged between light pipes and detector. However, for embodiments generally, the number of light detectors at the end of the light pipes is variable, much as the total number of light pipes is variable, from one embodiment to the next. Each light pipe may, for example, terminate in a separate respective detector. The particular quantities of light pipes and other components in an exemplary system depends on the desired configuration of the sensor.

The number and particular hardware features of controller 106 (e.g., a microcontroller) may vary among embodiments. For instance, exemplary but non-limiting commercially available microcontrollers which may be employed for some embodiments are sold under the name “STM32,” a family of 32-bit microcontroller integrated circuits by STMicroelectronics. In the exemplary embodiment of system 120 of FIG. 1A, the controller 106 includes an analog-to-digital converter (ADC) 108 and as many digital outputs as there are optical paths in the sensor. Alternative configurations may be used in other embodiments, however. For instance, an ADC may be provided externally to the controller. Various optical elements (lenses, etc.) may be used in addition to or instead of certain digital elements. In any event, digital processing of data is desirable in many embodiments, in which case provision is made for the light signals exiting the ends of the light pipes to be converted to digital (electronic) signals.

Exemplary signal processing for which one or more controllers 106 may be provided in embodiments may include but is not limited to averaging, accumulation, Kalman filters, and Gaussian Naive Bayes (GNB) classification. The output of signal processing steps may be or include indication of the air gap pattern(s) and/or their corresponding locations where deformation is occurring. This output may be provided to a human user or a downstream nonhuman user. For instance, an exemplary embodiment may be used with robotics (e.g., a robotic arm) as a feedback mechanism for improving and/or maintaining accuracy of the movement of the arm.

An exemplary controller 106 is also an exemplary means for controlling activation of the light source(s) 103 which may be activated in a rapid series (e.g., as FIG. 1A suggests) or all at once depending on the embodiment. Activation in series is advantageous where multiple emitters 103 emit the same type of light (e.g., infrared) but terminate at a shared detector 105. These features are not strictly required of all embodiments but are but are an advantageous approach to minimizing costs.

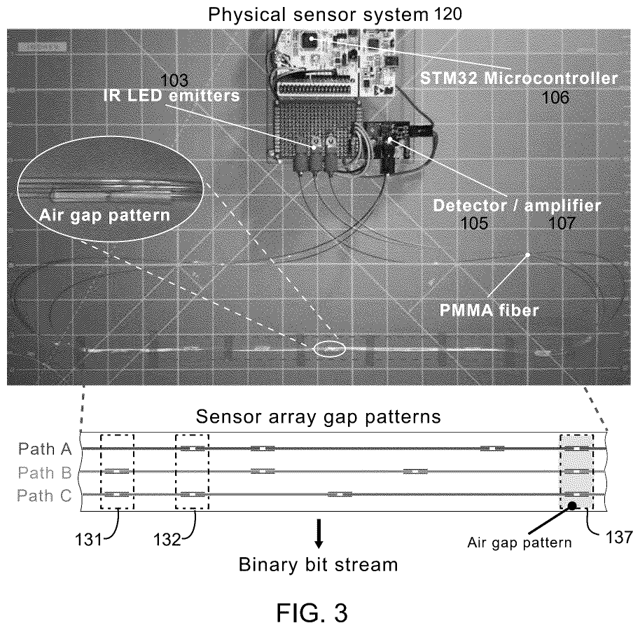

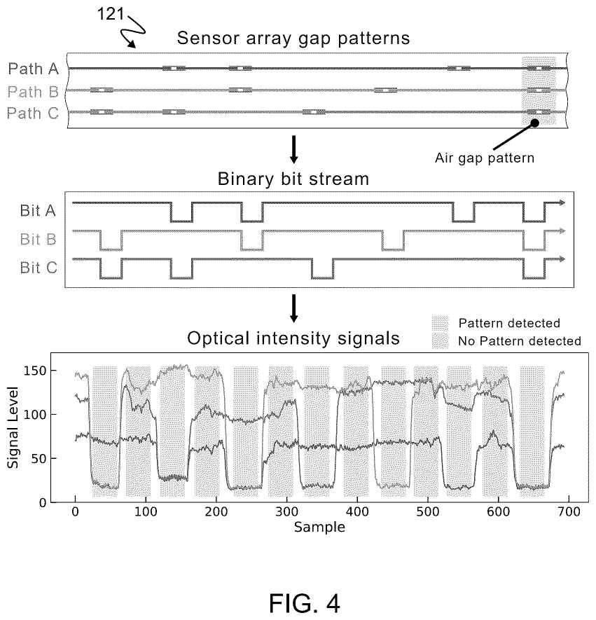

FIG. 3 and FIG. 4 depict the exemplary system 120 configured with physical components (as opposed to the partially diagrammatic format of FIG. 1) and a visual explanation of the sensor operation. Whereas FIG. 1 depicted only two locations, namely locations 131 and 132, FIGS. 3 and 4 depict the system 120 with seven discrete sensing locations (locations 131 and 132 plus five others). The seven respective air gap patterns, each unique for a different sensing location, form bit patterns equivalent to an inverse Gray code binary word sequence that translates to a corresponding bit stream pattern similar to an encoder pattern. Since the real-world bit stream is not a consistent absolute signal, a GNB classifier is an exemplary means for identifying the active patterns from the non-absolute optical signal.

The system 120 and sensor 121 shown in FIGS. 3 and 4 have air gap patterns which are evenly spaced apart from one another for the ease of comparison with illustrations of signals each pattern respectively produces when subjected to a local deformation. In practice, however, the air gap patterns may be placed anywhere along the length of the light pipes, with variable distance from one pattern to the next pattern, much like the gratings in fiber Bragg grating (FBG) sensors.

An exemplary sensor system such as sensor system 120 or sensors 121 and 125 may be used in place of an absolute linear encoder. Generally, a linear encoder measures the linear displacement of an object and typically consists of a slider rail with a coded scale (much like a measuring ruler) and a sensing head that slides over that scale and reads the scale. The reading of the scale may be achieved by magnetic, optical, capacitive, resistive, ultrasonic, inductive, or mechanical means. Absolute encoders output a unique pulse code at each step so the displacement relative to some scale is always known. More intuitively, an absolute encoder can be thought of as a ruler with the numbers and tick marks present, while an incremental encoder is the same ruler with tick marks but no numbers. Similar to an absolute encoder, the sensor system 120 may be configured to encode absolute positions along some distance.

The sensor system 120 encodes absolute positions using bend-sensitive air gap patterns along parallel light pipes. The pattern of the bend-sensitive air gaps used to encode the bend location follows an n-bit binary sequence, where n is the number of paths.

An exemplary system 120 may employ n-bit inverse gray code. Gray code is a sequence of n-bit binary numbers where only a single bit is changed when transitioning from one number to the next, which can also be thought of as the Hamming distance between two adjacent numbers in the sequence is 1. As shown in the first column of Table I, this can be a form of built-in error detection since a change of more than one bit in the sequence has to be an error. This makes Gray code or its derivatives especially advantageous as the coding for encoders like system 120.

The sensor system 120 comprises a GNB classifier to identify the active air gap pattern. Alternative embodiments may employ alternative means of identifying active air gap patterns. For embodiments which employ a GNB classifier or similar solution, it is desirable to maximize the information gain from one pattern to the next. Gray code minimizes the information gain from one pattern to the next, but inverse Gray code helps maximize the information gain from one pattern to the next. Inverse Gray code is where two adjacent n-bit numbers in the sequence differ by n−1 bits, which is the maximum number of bits that can change in a binary sequence. A 3-bit example of this inverse Gray code is shown in the second column of Table I.

TABLE 1
3-BIT GRAY CODE SEQUENCES

| Number | Gray code | Inverse Gray code |
|---|---|---|
| 0 | 000 | 000 |
| 1 | 001 | 110 |
| 2 | 011 | 011 |
| 3 | 010 | 101 |
| 4 | 110 | 010 |
| 5 | 111 | 100 |
| 6 | 101 | 001 |
| 7 | 100 | 111 |

The light pipes and their gaps belonging to a particular system like system 120 may be collectively referred to as a sensor or a sensor array. Each air gap pattern on the sensor array may be characterized as an n-bit binary word in an inverse Gray code sequence. The inverse Gray code of number 1 in Table I corresponds with the first vertical pattern of air gaps at location 131 in FIG. 1A and FIG. 3. Similarly, number 7 in Table I corresponds with the last vertical pattern of air gaps in FIG. 3, at location 137. When a bend happens at an air gap pattern location, the attenuation in optical intensity results in the binary bit stream shown in FIG. 4 and is similar to the pulse pattern generated by an absolute encoder. Unlike an encoder, the real intensity signals, shown in FIG. 4, may not be consistent enough to directly convert to a binary signal. This issue may be addressed by the use of, for example, a GNB classifier. Finally, each n-fiber sensor is limited to 2ⁿ−1 sensitive patterns due to each pattern being equivalent to a binary word.

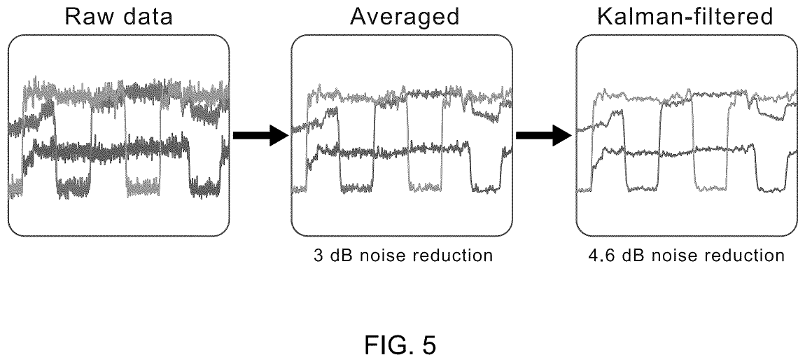

FIG. 5 summarizes exemplary signal processing stages for noise reduction of the output signal of a sensor array. The progression depicted in FIG. 5 corresponds with the block diagram within controller 106 FIG. 1A. Before being sent to the GNB classifier, the signals go through a two-stage noise reduction signal processing chain shown. First, the signal is averaged, which produces a first noise reduction, and then it is Kalman-filtered for an additional noise reduction.

A simple exemplary averaging filter is given by

$$A = \frac{1}{n} {\sum }_{i = 1}^{n} {a}_{i}$$

where n is the number of values to be averaged. This filter serves both to smooth the raw data as well as stabilize the readings for the classifier by providing a slight delay. After the initial smoothing, a filter such as a Kalman filter may be used to further reduce remaining signal noise without introducing any significant delay in the signal chain. A Kalman filter is an optimal and recursive algorithm that can estimate a target value using both a current measurement as well as the a priori knowledge about the system. These filters are especially suitable for exemplary applications of present embodiments due to both being computationally efficient and simple enough to run on a microcontroller. However, those of skill in the art may recognize suitable alternatives to employ in embodiments beyond this illustrative example.

A Gaussian Naive Bayes (GNB) classifier is a supervised learning algorithm based on Bayes' theorem that determines how a measurement can be assigned to a particular class, Cᵢ, assuming each class follows a Gaussian (normal) distribution with a certain probability P(Cᵢ).

The naive part of the name assumes independent random variables. The operation of the GNB classifier may be described in the context of two questions: (1) How can a measurement, x, be assigned to class Cᵢ for a given distribution? (2) What is the probability of error in that assignment?

The answer to the first question has an intuitive start: given any number of classes, a measurement should most likely belong to the class that has the highest probability of occurring. This means that, assuming the class follows a Gaussian distribution, a measurement x belongs to class Cᵢ, ∈[1, M] when

$$max \{ {f}_{x} ( x \vert {C}_{i} ) P ( {C}_{i} ) ∀ i ∈ [ 1 , M ] \}$$

with the Gaussian probability density function given by

$$P ( x \vert {C}_{i} ) = \frac{1}{\sqrt{2 {πσ}_{{c}_{i}}}} exp {( - \frac{( x - {μ}_{{c}_{i}} )}{2 {σ}_{{c}_{i}}} )}^{2}$$

Addressing the second question, the probability of error is the probability of a measurement, x, from one class being misclassified as belonging to a different class. Given a two-class problem, the total probability of error is defined as

$${P}_{err} = P ( x \vert {C}_{2} ) P ( {C}_{2} ) x ∈ {C}_{1} + P ( x \vert {C}_{1} ) P ( {C}_{1} ) x ∈ {C}_{2}$$

A GNB is exemplary for some embodiments because it is more efficient than if-statements or lookup tables, can handle new or previously unseen data, and can be more accurate by taking into account the relationships between multiple input variables.

This paragraph summarizes a non-limiting example for fitting and prediction. Fitting of the training data to a usable GNB classifier may be performed using the GaussianNB module of the popular Scikit-learn Python library. In order to fit the model, data for each air gap pattern is captured from the sensor, labeled appropriately, then sent to the GaussianNB module. The output of the fitting process is a set of parameters representing the various Gaussian distributions and probabilities for each pattern as determined by the sensor data. The actual prediction is performed by a GNB classifier on the system microcontroller, implemented using the Arm CMSIS-DSP C library which contains common signal processing functions. This allowed the microcontroller to perform real-time predictions while offloading the compute-intensive fitting process to a desktop computer.

Exemplary sensors and sensor systems may be made with different diameter fibers and fiber materials. A number of sensor system properties may affect the system's behavior and usability for different applications. Several properties are summarized in Table II.

TABLE II
OPTIGAP SENSOR SYSTEM PROPERTIES & PARAMETERS

| Name | Has An Effect On |
|---|---|
| Bend Sensitivity | Min bend angle for intensity drop |
| Diameter | Total transmittance based on light source |
| Gap Length | Bend sensitivity |
| Sensing Resolution | Minimum length between gaps |

The light pipe material is an important property because it greatly influences the total length of the sensor, the flexibility of the sensor, and the ability of the sensor to be embedded in various media. In general, many embodiments benefit from light pipe material having a very optically clear core with good flexibility. For instance, polymethyl methacrylate (PMMA) fiber is a versatile light pipe material due to its great optical properties, availability in various diameters, and general flexibility without breaking. Another material that may be employed in some embodiments is thermoplastic polyurethane (TPU). Other materials may also be employed depending on the intended use context for a sensor and system.

The material which maintains and often covers an air gap (e.g., sleeve 134 in FIG. 1A) is generally selected to be soft enough to allow deformation (e.g., bending) to occur at the gap without being so soft as to crumple easily. An exemplary softness for some embodiments may equate to a Shore hardness of about 55A. A relaxed inner diameter of a sleeve material may be smaller than the light pipe diameter so that it must be tensioned to fit around the light pipe outer diameter. This arrangement assists in the sleeve material firmly gripping the light pipe exterior surface. A high-temperature silicone is one exemplary material. High-temperature silicone tubing is commercially available, e.g., under part numbers 51845K66 and 51845K67 from McMaster-Carr.

Some embodiments may be configured for use underwater. Exemplary sensors may perform equally well submerged and in free air. This makes embodiments applicable in use cases such as but not limited to underwater robotics.

Some embodiments may be configured to only detect bending at one location at a time, consistent with expected behavior of linear encoders. Other embodiments may be configured to detect bending at multiple locations at a time. For the latter scenario, embodiments may, for example, have gaps which are not all alike in their effects on light when subjected to the same amount and type of deformation. Classifiers other than a GNB classifier may be used.

### Example

Certain embodiments of the invention are discussed in P. Bupe and C. K. Harnett, “OptiGap: A Modular Optical Sensor System for Bend Localization,” 2023 IEEE International Conference on Robotics and Automation (ICRA), London, United Kingdom, 2023, pp. 620-626, doi: 10.1109/ICRA48891.2023.10161357, which is herein incorporated by reference in its entirety. Other embodiments of the invention are discussed in <<paulbupejr.com/developing-the-optigap-sensor-system>>, which is herein incorporated by reference in its entirety. Some embodiments of the invention are discussed in P. Bupe et al., “Embedded Optical Waveguide Sensors for Dynamic Behavior Monitoring in Twisted-Beam Structures,” 2024 IEEE 7th International Conference on Soft Robotics (RoboSoft), San Diego, CA, USA, 2024, pp. 139-144, doi: 10.1109/RoboSoft60065.2024.10521938, which is herein incorporated by reference in its entirety. Further embodiments of the invention are discussed in Bupe, Paul Jr, “A modular framework for surface-embedded actuation and optical sensing in soft robots.” (2023). Electronic Theses and Dissertations; Paper 4213; doi.org/10.18297/etd/4213, which is herein incorporated by reference in its entirety.

This Example discusses validation of an exemplary sensor system modeled after FIG. 1A through simulation using COMSOL Multiphysics and then a physical prototype consistent with FIG. 3.

For a simulation embodiment, ray optics simulations were used instead of wave optics because exemplary systems are designed to operate with multiple materials; the fiber was treated as a generic light pipe and is not material-dependent. The simulation entailed the bending of a piece of PMMA fiber with an air gap of 1 mm and of 2 mm. For reference, the simulation further entailed the bending of a piece of fiber with no air gap present.

For a physical embodiment, the FIG. 3 system was assembled in accordance with the above description. PMMA fiber commercially available under part numbers CK-20 and CK-30 from Industrial Fiber Optics with nominal diameters of 0.5 mm and 0.75 mm, respectively, were used. Both fibers have a fluorinated polymer cladding, a core refractive index of 1.49, and a numerical aperture of 0.5. The light sources were IR LEDs. Fitting of training data to a usable GNB classifier was performed using the GaussianNB module of the popular Scikit-learn Python library. In order to fit the model, data for each air gap pattern was captured from the sensor, labeled appropriately, then sent to the GaussianNB module. The output of the fitting process is a set of parameters representing the various Gaussian distributions and probabilities for each pattern as determined by the sensor data. The actual prediction was performed by a GNB classifier on the system microcontroller, implemented using the Arm CMSIS-DSP C library which contains common signal processing functions. This allowed the microcontroller to perform real-time predictions while offloading the compute-intensive fitting process to a desktop computer.

Table III gives nonlimiting variations for the system of FIG. 3 including different diameter fibers and optical fiber materials which were also tested. For PMMA fibers, the optical combiner entailed the three fibers in a silicone tube connected to the optical detector. Since TPU fibers are bigger, the combiner selected was a commercial 3:1 optical fiber combiner (Industrial Fiber optics part 97638-001, Industrial Fiberoptics Inc).

TABLE III
OFTIGAP CONFIGURATIONS TESTED

| Length (m) | Material | Diameter (mm) | Air Gap Patterns |
|---|---|---|---|
| 1.1 (Sensor A) | PMMA (fiber) | 0.5 | 7 |
| 1.3 (Sensor B) | PMMA (fiber) | 0.75 | 7 |
| 0.7 (Sensor C) | TPU (filament) | 1.75 | 3 |

To account for different types of light source lenses, this Example examined through simulation the effects of changing the cone angle of the light source. To empirically test the bending of the fiber, a CAD pattern was drawn and printed that contained outlines of all the test bend angles. The fiber was then aligned on top of the paper for each bend angle, allowing for consistent and repeatable testing. Transmittance was treated as the ratio of transmitted light to incident light, as given by:

$$T = \frac{I}{{I}_{0}}$$

### Bend Angle Affect on Signal Transmittance/Attenuation

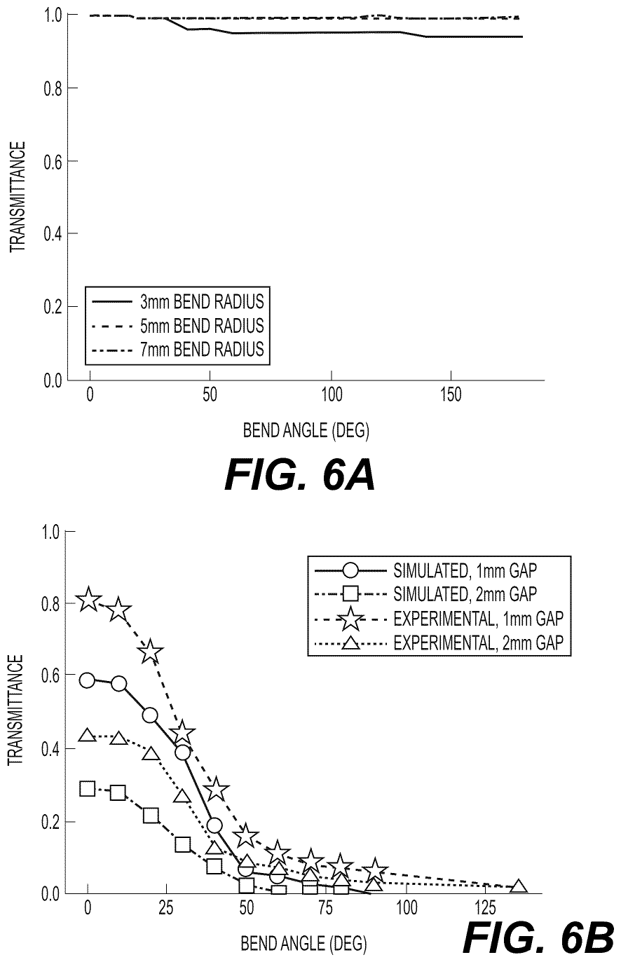

FIG. 6A plots transmittance as a function of bend angle (deg) when simulating bending a 1 mm piece of PMMA fiber which had no air gap. Bending a fiber with no air gap resulted in minimal loss of light as the simulation in FIG. 6A shows. A minimal drop-off starts at around 40°. For the smallest 3 mm bend angle, a 180° bend resulted in only a 6% drop in transmittance. In contrast to FIG. 6A, FIG. 6B plots transmittance as a function of bend angle (deg) when bending fiber at the location of an air gap. The graph includes both simulated and experimental data for a 1 mm gap and also for a 2 mm gap. The simulation and experimental data follow the same curves even though the experimental data has a higher offset. An exemplary air gap may be configured to significantly reduces transmittance as the bend angle increases. The presence of an air gap resulted in a 75% drop by 50° and effectively a total loss in transmittance by 125°, as shown in FIG. 6B. The experimental results in the same figure match the simulation in terms of percentage drop. For both simulation and empirical prototype, the drop in transmittance starts accelerating at 20° with most of the light attenuated by 50°. This establishes 20° as a working angle for a recognizable bend for this particular prototypical sensor. Working angle may be defined for some embodiments as the minimum bend angle required to reliably detect a bend. The offset between the experimental and simulation results is due to the simulation optical source not matching the intensity of the experimental source LED.

### Gap Size

In general, an increase in gap size (distance between opposing faces) increases the bend sensitivity at the cost of lower transmittance of the entire fiber. FIG. 6B shows that the effective bend sensitivity of the sensor can be changed by changing the gap length, which in turn changes the minimum working angle. This effect can be alleviated, if necessary, by using a more powerful light source(s) in embodiments.

### Light Source Cone Angle and Light Pipe Diameter

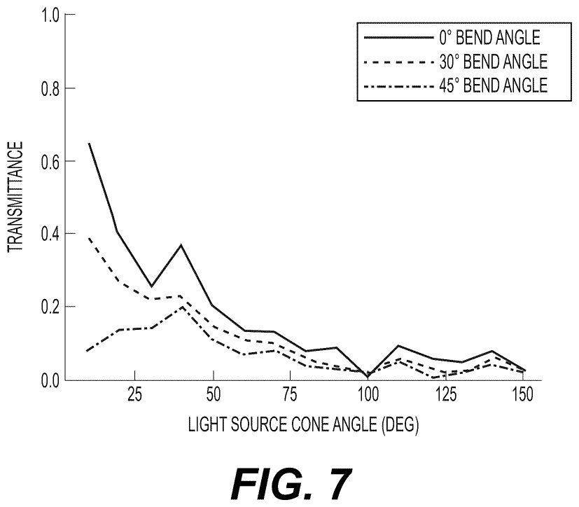

The cone angle of the light source has a noticeable impact on transmittance. FIG. 7 shows simulated effect of light source cone angle (deg) on transmittance for three sample bend angles. Simulation results in FIG. 7 show that small cone angles produce the highest transmittance. In general, the smaller the cone angle the higher the transmittance, despite the experimental data in FIG. 7 showing extra sensitivity at 40° during the downward trend. The results depicted in FIG. 7 suggests that the diameter of the light pipe has a direct effect on the optical intensity and thus maximum sensor distance. The transmittance may be maximized by using a light source with the smallest possible cone angle if multiple diameter fibers are going to be used, or by matching the light source to the fiber diameter if a single diameter is used for the application.

### Sensing Resolution

For embodiments configured to expect only one air gap pattern bending at a time, the bend sensitivity may be chosen based on desired sensing resolution, or vice versa. Sensing resolution may be defined as the minimum gap-to-gap spacing. For a number of (but not necessarily all) applications, 5 cm is a reasonable resolution for most materials.

### Full System and Classifier Performance

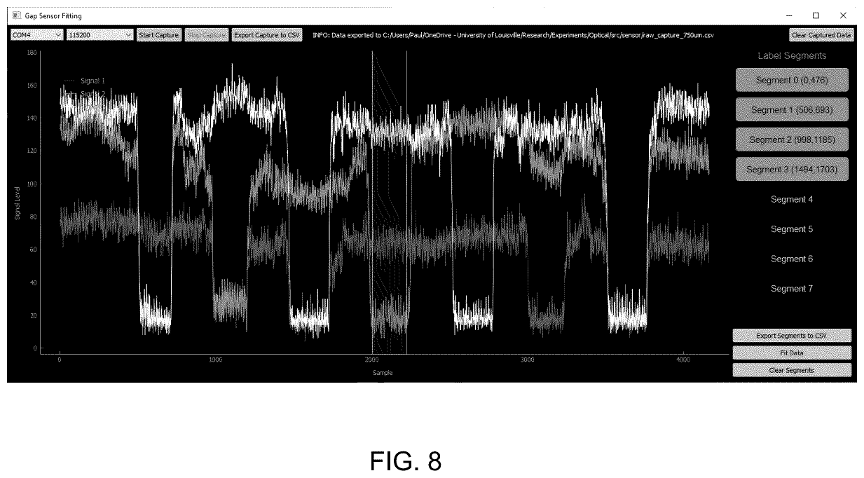

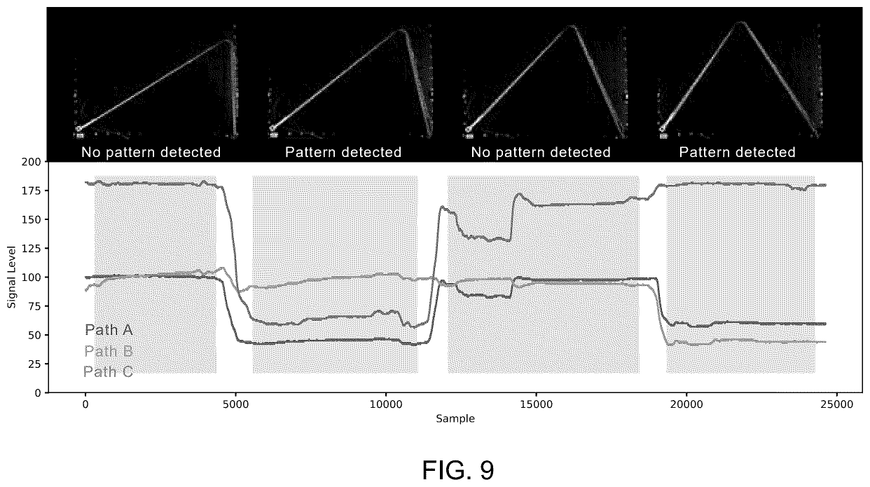

To make the prototypical system easily usable and reconfigurable, the system according to FIG. 3 was connected to a display device which displayed a graphical user interface (GUI) of which FIG. 8 is a screenshot. An exemplary GUI may enable quick data gathering from the sensors, interactive data labeling, and model fitting. Initial tests entailed hand bending the sensor and verifying the classification. For repeatability, an automated bending rig was created consisting of a tape spring arm with a servo (i.e., servomotor) on one end and a free-spinning shaft on the other end. This rig is depicted in the top of FIG. 9. Results, depicted in the bottom of FIG. 9, show the output tracked with the location of the bend along the arm, showing the bend-sensitive areas and the non-sensitive areas. The signal from the sensor array was averaged, which produced a 3 dB noise reduction, and then it was Kalman-filtered for an additional 4.6 dB noise reduction. The resulting signal was then sent to the GNB classifier. While there is no single accuracy metric for the system as a whole since that is entirely dependent on the fitting and fabrication of a particular configuration, this configuration tested had a 100% accuracy measure. However, one potential source of error is little separation between low and high signal levels, which can occur if the gap lengths are too large, resulting in transmittance below a usable threshold. Using the STM32 running at 100 MHz, the sensor was outputting data at 175 Hz using a UART baud rate of 115200.

### Sensor Attachment

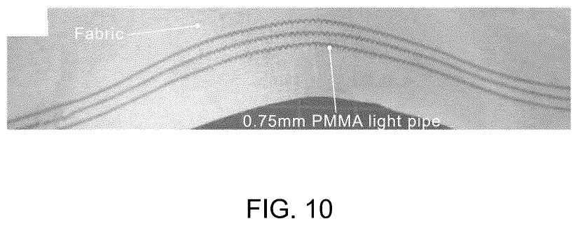

Various techniques for attaching the sensors to mechanisms was explored, including tapes such as masking, painter's, fabric, and polyimide tape. Polyimide tape was the most versatile especially when sticking the sensor to our tape spring test station. Other techniques included using flexible but stabilizing material like a thin PET sheet as well as flexible silicone adhesives. For an embeddable sensor that could sense the bending of the material in which the sensor is embedded, a ZSK tailored wire placement machine was used to sew fibers for a sensor into a fabric material, as depicted in FIG. 10. In practice, an exemplary sensor may be embedded directly into some fabric or device during fabrication of that fabric or device.

Where a range of values is provided in this disclosure, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are described.

As used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely”, “only”, and the like in connection with the recitation of claim elements, or use of a “negative” limitation.

As will be apparent to those of skill in the art upon reading this disclosure, each of the individual embodiments described and illustrated herein has discrete components and features which may be separated from or combined with the features of any of the other several embodiments without departing from the scope or spirit of the present invention. Any recited method can be carried out in the order of events recited or in any other order which is logically possible.

Some embodiments of the present invention may be a system, a device, a method, and/or a computer program product. A system, device, or computer program product may include a computer readable storage medium (or media) having computer readable program instructions thereon for causing a processor to carry out aspects of the present invention, e.g., processes or parts of processes or a combination of processes described herein.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Processes described herein, or steps thereof, may be embodied in computer readable program instructions which may be paired with or downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions and in various combinations.

These computer readable program instructions may be provided to one or more processors of one or more general purpose computers, special purpose computers, or other programmable data processing apparatuses to produce a machine or system, such that the instructions, which execute via the processor(s) of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the invention has been described herein in connection with exemplary embodiments and features, one skilled in the art will recognize that the invention is not limited by the disclosure and that various changes and modifications may be made without departing from the scope of the invention as defined by the appended claims.

What is claimed is:

1. An optical sensor for localizing deformations among at least a first location, second location, and third location, comprising
a first light pipe comprising along its length at least a first gap and a second gap; and
a second light pipe comprising along its length at least a third gap and a fourth gap;
wherein the first gap and third gap share a first location,
wherein the second gap has a second location which is not shared with the first, third, or fourth gap,
wherein the fourth gap has a third location which is not shared with the first, second, or third gap,
wherein each gap is configured to have light transmission properties which change in response to deformation.

2. The optical sensor of claim 1, wherein each location with at least one gap has a unique air gap pattern.

3. The optical sensor of claim 2, wherein each unique air gap pattern is configured to form a unique bit pattern equivalent to a binary word sequence.

4. The optical sensor of claim 1, wherein each gap is an air gap.

5. The optical sensor of claim 1, wherein each gap comprises 4 mm or less between opposing faces of light pipe.

6. The optical sensor of claim 1, wherein a total number of locations for which the optical sensor is configured to localize a deformation exceeds a total number of light pipes by at least one.

7. The optical sensor of claim 1, further comprising one or more claddings configured to constrain gaps to remain at their respective locations.

8. A deformation localization sensor system, comprising
at least one optical sensor according to claim 1;
one or more emitters;
one or more detectors; and
at least one controller configured to classify detected air gap patterns.

9. The deformation localization sensor system of claim 8, wherein the controller is a microcontroller.

10. The deformation localization sensor system of claim 8, wherein the controller is programmed with a classifier to classify detected air gap patterns.

11. The deformation localization sensor system of claim 8, wherein the one or more emitters are emitters of infrared (IR) light.

12. The deformation localization sensor system of claim 8, wherein each location with at least one gap has a unique air gap pattern.

13. The optical sensor of claim 12, wherein each unique air gap pattern is configured to form a unique bit pattern equivalent to an inverse Gray code binary word sequence.

14. The deformation localization sensor system of claim 8, wherein each gap is an air gap.

15. The deformation localization sensor system of claim 8, wherein each gap comprises 4 mm or less between opposing faces of light pipe.

16. The deformation localization sensor system of claim 8, wherein a total number of locations for which the optical sensor is configured to localize a deformation exceeds a total number of light pipes by at least one.

17. The deformation localization sensor system of claim 8, further comprising one or more claddings configured to constrain gaps to remain at their respective locations.

18. A method of localizing deformation along a length, comprising
providing a system according to claim 8;
emitting first light signals with the one or more emitters into first terminal ends of the first and second light pipes;
detecting second light signals with the one or more detectors from second terminal ends of the first and second light pipes; and
classifying detected air gap patterns with the at least one controller.
